(19) United States
(12) Patent Application Publication
(10) Pub. No.: US 2020/0372457 A1
(43) Pub. Date: Nov. 26, 2020

(54) Waste Shipping Manifest with Integrated Audit Data

(71) Applicant: Waste Repurposing International, Inc., Austin, TX (US)

(72) Inventor: Christopher Barnard Ripley, Lichtfield, CT (US)

(73) Assignee: Waste Repurposing International, Inc., Austin, TX (US)

(21) Appl. No.: 16/860,013

(22) Filed: Apr. 27, 2020

Related U.S. Application Data
(60) Provisional application No. 62/838,775, filed on Apr. 25, 2019.

(51) Int. Cl. G06Q 10/08; G06Q 10/00; G06F 3/0488; G06K 7/14

(52) U.S. Cl. CPC G06Q 10/0832; G06Q 10/0875; G06K 7/1404; G06Q 10/30; G06F 3/04883; G06Q 10/0833

(57) ABSTRACT

Systems, methods, and devices provide source-to-destination tracking of hazardous waste products. The systems, methods, and devices operate in conjunction with printed Uniform Hazardous Waste Manifest (UHWM) forms by printing the forms and then allowing the user to scan the signed UHWM forms into the system. The systems, methods and devices may provide a UHWM electronic form that includes a signature field to receive a digital signature. When waste products are to be transported, a user may sign the UHWM form either digitally or on the printed UHWM form. Each time the waste products exchange hands, from source to destination, a responsible party signs the UHWM form to append his or her signature. Variations between previously submitted and the current version of the UHWM form may be determined from the electronic form or from scanned versions of the printed form and differences may cause the system to generate an alert.

### FIELD

This application is a non-provisional of and claims priority to U.S. Provisional Application No. 62/838,775 filed on Apr. 25, 2019 and entitled “Waste Shipping Manifest with Integrated Audit Data”, which is incorporated herein by reference in its entirety.

### FIELD

The present disclosure is generally related to printing of shipping manifest documents for transporting waste, including household hazardous waste. More particularly, the present disclosure relates to generation of waste shipping manifests with integrated audit data.

### BACKGROUND

The Resource Conservation and Recovery Act (RCRA), enacted in 1976, defines regulations for waste disposal. The regulations define three classes of actors who handle waste: waste generators (waste sources), waste transporters, and waste disposal sites (e.g., treatment, storage, and disposal facilities (TSDFs)). The regulations further define waste products as hazardous under certain conditions, such as if the product contains one or more predetermined chemicals or if the product exhibits at least one of four characteristics: flammability, corrosivity, reactivity, or toxicity. The RCRA also authorized the Environmental Protection Agency (EPA) to promulgate standards governing hazardous wastes.

Currently, the EPA and the United States Department of Transportation (USDOT) require the use of a standard manifest document, known as a Uniform Hazardous Waste Manifest, which must accompany all hazardous waste shipments from the point where the waste is generated to the site of disposal. This manifest is a legal document used to prove chain of custody in the event of a spill, leak, or other issue. The manifest is produced with six copies for each page, with one copy apiece for the various participants in the process (such as waste generators, waste transporters, waste treatment facilities, state agencies, disposal sites, and the like). Each party that handles the waste signs the manifest and retains a copy. Once the waste reaches its destination, the receiving facility may return a signed copy of the manifest to the waste generator to confirm receipt of the waste. Thus, the hazardous waste manifest ensures accountability across multiple entities in the transportation and disposal processes.

Conventionally, the Uniform Hazardous Waste Manifest (UHWM) form may be obtained only from sources that have been approved by the EPA and placed on an EPA Manifest Registry to print and distribute the form. At this time, only nine companies are approved to print the UHWM form. Each printed UHWM form includes a unique three-letter suffix to be used as part of a unique tracking number (manifest tracking number or MTN) on each manifest.

### SUMMARY

Embodiments of systems, methods, and devices are described herein that facilitate and enable the collection, transportation, and disposal of waste products in compliance with EPA and DOT regulations. In some implementations, a portable computing system may be configured to receive information related to waste items for disposal and to print the information onto a pre-printed paper form to produce a UHWM form. The portable computing system may prompt the user to acquire one or more signatures on the paper form and then to scan the signed UHWM form using a scanning device, such as a wand scanner, a sheet-feeder or flatbed scanner, or a digital camera. The scanned UHWM form may be sent to a waste management system via a network.

In some implementations, the portable computing system may be associated with a vehicle for transportation of the waste product. A driver or other user may access the computing system to receive data corresponding to waste products to be removed. The driver may move the waste products onto the truck, scan them, and place them into an appropriate bin (which may be identified on a display of the computing system). Once the waste items are scanned and placed in the appropriate bins, the computer system may be used to print the information onto a pre-printed form to product the UHWM form. The form may then be signed by one or more of an employee of the waste source or the driver and may be scanned and uploaded to a waste management system via a network. When the waste products are delivered to a destination, the UHWM form may be signed by an employee at the destination, and the newly signed (updated) UHWM form may be scanned and uploaded to the waste management system. In this example, the portable computing system may facilitate the collection and documentation of the waste products for the transporter, the source, and the destination.

In some implementations, the systems, methods, and devices may be used to provide a “paperless” process. The systems, methods, and devices may provide a Uniform Hazardous Waste Manifest (UHWM) electronic form that may include a signature field to receive a digital signature. When the UHWM electronic form is first populated with data related to waste products to be transported, a user associated with the source of the waste products may digitally sign the UHWM electronic form. Each time the waste products exchange hands, from source to destination, a responsible party accesses a version of the UHWM electronic form to append his or her signature. Variations between previously submitted and the current version of the UHWM electronic form may cause the system to generate an alert.

Embodiments of systems, methods, and devices are described below that may be used to digitally generate a Uniform Hazardous Waste Manifest including information about waste products and including information about the individuals who packaged or handled the waste products, providing a manifest with an integrated audit trail. The UHWM form may be signed digitally, and the signed UHWM form may be printed for each party handling the waste, either at the site of the waste transfer or at a computing device communicatively coupled to a server. In some implementations, the server may implement block chain protocols to ensure integrity of the data.

Embodiments of systems, methods, and devices are described below that enable source-to-destination tracking and auditing of waste shipping manifests, such as Environmental Protection Agency (EPA) Electronic manifests (E-Manifests). The E-Manifest may include a digital tracking signature, such as a manifest tracking number, which may be implemented both numerically and as a barcode. From the generator (waste source) to the transporter and from the transporter to the Treatment, Storage, and Disposal Facility (TSDF) (and every step in between), the E-manifest may be scanned and data related to the scan may be sent to a waste management system, which may maintain a centralized database of E-Manifest data, together with related audit information. Such audit information may include operator identification data (username, image data, biometric data, signature, other data, or any combination thereof), date and time stamp data, location data, product data, and so on, for each stage of the waste handling process.

In some embodiments, a method of creating a Uniform Hazardous Waste Manifest (UHWM) for tracking a shipment of hazardous waste may include generating, using a computing device, a digital manifest including waste data corresponding to waste products in a shipping container. The method may further include providing a graphical interface to a touchscreen or other display device. The graphical interface may include the digital manifest and a signature input field, and the user may interact with the graphical interface to provide a signature via the touchscreen or another input device. The device may capture image data corresponding to the user while the signature data is being received. Additionally, the method may include generating a multi-dimensional signature value based on the signature data and the image data and may include providing the digital manifest including the signature data and the multi-dimensional signature value. In some implementations, the multi-dimensional signature value may include image data of the product, image data of the user, date and time data, location data, other data, or any combination thereof.

In some implementations, a system may include a computing device. The computing device may include a communications interface to communicate with a communications network, an input/output device including a touchscreen, and a processor coupled to the network interface, the display, and the touch-sensitive interface. The computing device may also include a memory accessible to the processor and configured to store data and processor-executable instructions that, when executed, cause the processor to provide an interface including a Uniform Hazardous Waste Manifest (UHWM) electronic form to the touchscreen. The UHWM electronic form may include one or more fields including a signature field to receive an electronic signature. The instructions may cause the processor to receive data corresponding to the UHWM electronic form including a digital signature, store the UHWM electronic form in a datastore within the memory, and send the UHWM electronic form and associated data to a waste management system through the communications network.

In other implementations, a system may include a waste management system. The waste management system may include a communications interface to communicate with a network, a processor coupled to the communications interface, and a memory accessible to the processor. The memory may store data and may store processor-readable instructions that, when executed, cause the processor to receive a first Uniform Hazardous Waste Manifest (UHWM) electronic form including one or more digital signatures from a first computing device through the network. The instructions may cause the processor to store the UHWM electronic form in a data store within the memory, receive an updated version of the first UHWM electronic form from one of the first computing device or a second computing device through the network, and store the updated version of the first UHWM electronic form in the data store. The instructions may cause the processor to compare one or more first values of the first UHWM electronic form to one or more second values of the updated version of the first UHWM electronic form and generate an alert in response to a difference between the one or more first values and the one or more second values.

In still other implementations, a method may include providing a graphical interface to a touchscreen of a computing device. The graphical interface may include a Uniform Hazardous Waste Manifest (UHWM) electronic form including a signature input field to receive a digital signature. The method may include receiving a digital signature data corresponding to the signature input field from the touchscreen display, capturing image data corresponding to a user concurrently with receiving the digital signature data, and sending the UHWM electronic form to a waste management system through a network.

### BRIEF DESCRIPTION OF THE DRAWINGS

The detailed description is set forth with reference to the accompanying figures. In the figures, the left most digit(s) of a reference number identifies the figure in which the reference number first appears. The use of the same reference numbers in different figures indicates similar or identical items or features.

FIG. 1 depicts a diagram of a system to capture data related to waste products and to generate a shipping manifest including integrated audit data, in accordance with certain embodiments of the present disclosure.

FIG. 2 depicts a diagram of a method of generating data related to a shipping container, in accordance with certain embodiments of the present disclosure.

FIG. 3 depicts a block diagram of a waste management system, in accordance with certain embodiments of the present disclosure.

FIG. 4 depicts a block diagram of a computing device, in accordance with certain embodiments of the present disclosure.

FIG. 5 depicts a block diagram of a waste disposal system, in accordance with certain embodiments of the present disclosure.

FIG. 6 depicts a diagram of a form including integrated audit data, in accordance with certain embodiments of the present disclosure.

FIG. 7 depicts a flow diagram of a method of generating a multi-dimensional signature value, in accordance with certain embodiments of the present disclosure.

FIG. 8 depicts a flow diagram of a method of generating a shipping manifest, in accordance with certain embodiments of the present disclosure.

FIG. 9 depicts a flow diagram of a method of capturing data related to a signed shipping manifest, in accordance with certain embodiments of the present disclosure.

While implementations are described in this disclosure by way of example, those skilled in the art will recognize that the implementations are not limited to the examples or figures described. The figures and detailed description thereto are not intended to limit implementations to the form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the work “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

Embodiments of systems, methods, and devices are described below that enable source-to-destination tracking and auditing of shipments of hazardous waste. In some implementations, the system may be used to capture information about one or more waste products and to print the information onto a preprinted Uniform Hazardous Waste Manifest (UHWM) form. The UHWM form may then be signed by one or more of the transporter, an employee of the source, or an employee of the destination. The signed UHWM form may then be scanned and uploaded to a waste management system, which may store the executed UHWM forms in a database. In this example, the paper form may include multiple carbon pages, and a copy of the signed form may be kept by the source, by the transporter, and by the destination.

In some implementations, the data collection and the forms may be maintained electronically, facilitating documentation of the collection, transportation, and disposal of hazardous waste. The systems may enable capturing of digital manifest data and digital signatures at each transfer of hazardous waste, from source to destination, and the captured digital manifest data may be used to generate a Uniform Hazardous Waste Manifest (UHWM) form including signatures and associated data providing a chain-of-custody from source-to-destination. In some instances, a copy of the UHWM form may be printed at each exchange, so that company handing over the waste can receive a receipt.

In some implementations, the UHWM form or EPA E-Manifest may include data required by the EPA and optionally other government agencies (such as the USDOT) and may include additional information including audit data, signature data, and other data that can be used to verify each stage of the handling of a waste product. The E-Manifest may include a digital tracking signature, such as a manifest tracking number, which may be included in the E-Manifest as a unique number and associated barcode. From the generator (waste source) to the transporter and from the transporter to the Treatment, Storage, and Disposal Facility (TSDF) (and every step in between), the E-manifest may be scanned and data related to the scan (including related audit information, such as user information, user and product images, location data, date and time stamp data, digital signature, images of the signer, and so on) may be sent to a waste management system, which may maintain a centralized database of E-Manifest data.

Human actors play an important role in the handling of the waste products. While the UHWM form requires signatures at various stages and by various actors in the waste handling process, conventionally such signatures cannot be readily verified. Embodiments of the systems, methods, and devices described below may capture signature data and image data (including images of the products, the product containers, and individuals signing the forms) at each stage of the waste handling process, enabling source-to-destination tracking of waste data. In some examples, waste data, signature data, and image data associated with the signer may be combined (by a computing device of a user or by a waste management system coupled to the computing device through a communications network) to form a multi-dimensional signature value, which may be embedded in the shipping manifest and which may be accessed at any time to verify the signatories and the waste data. In some implementations, the multi-dimensional signature value may include one or more of current signature data, an image of the signer, date data, time data, geophysical location data, waste product data, or other data. In some instances, the multi-dimensional signature value may also include data determined from a previously applied multi-dimensional signature value. For example, when a user of a computing device associated with a source of the waste product generates the UHWM electronic form and signs it, a first multi-dimensional signature value may be generated that may include one or more of the signature data, an image of the signer, date data, time data, geophysical location data, waste product data, or other data. When a transporter accepts the waste and digitally signs the UHWM electronic form, a second multi-dimensional signature value may be generated, which may include one or more of an image of the signer, date data, time data, geophysical location data, waste product data, or other data and which may include data determined from the first multi-dimensional signature value. As each new multi-dimensional signature value is created, data from a previously multi-dimensional signature value may be included, such that the signatures are linked, providing an audit trail that can be readily verified by the waste management system. Other implementations are also possible.

In some implementations, the system may include hardware devices that enable scanning, classification, tracking, and auditing of waste products and associated UHWM electronic forms (EPA E-manifests) as the waste products are transferred from one responsible party to the next (from source to destination). For example, an initial UHWM electronic form (EPA E-manifest) may be created by the generator (a device associated with the source of the waste product, such as a retailer disposing of an unsaleable product). The user of the device may add one or more items to the UHWM electronic form and then sign the UHWM electronic form, for example, by physically signing on a touch-sensitive surface (such as a touchscreen, a signature pad, or other device). The signature may represent verification of one or more waste items by the signer. Additionally, at the time of signing, the computing device may capture an image of the person doing the signing.

When a transporter arrives to pick up the waste items, the transporter may edit the UHWM electronic form by adding his or her signature, assuming responsibility for the waste items. Once again, the device may capture an image of the person doing the signing. At each stage of the transportation process, each user may digitally sign the UHWM electronic form until a person signs the UHWM electronic form at the destination and a corresponding picture is captured. In some implementations, date data, time data, location data, user image data, digital signature data, and other data may be combined to produce a multi-dimensional signature value that may be embedded in the UHWM electronic form. Further, the UHWM electronic form may be stored on a portable computing device and may be stored on a waste management system or other server device via a network.

When the waste products are transferred from the generator to the transporter, the transfer of the waste products may trigger a signature event in which the transporter signs the UHWM electronic form, assuming responsibility for the waste products. At this point, the weight and itemized contents of the shipping container may be verified, and the container may be sealed. Alternatively, the contents of the shipping container and the weight of the shipping container may be verified by a user associated with the waste source (waste generator) prior to sealing. In either case, the transporter may sign the UHWM electronic form, such as by digitally signing the UHWM electronic form using a touch-sensitive surface. The signature on the UHWM electronic form may represent the transporter's acceptance of the waste products in the manifest and the transporter's confirmation of the contents as well as assumption of responsibility for the handling of those contents. The UHWM electronic form may be updated with a multi-dimensional signature value based on the transporter's signature and an image of the signer. The multi-dimensional signature value may be embedded in the UHWM electronic form using a device associated with the transporter of the waste product. For example, a vehicle associated with the transporter may include a computing device configured to optically scan and weigh each shipping container, the waste products, or both, and to capture the operator's image and other information, which may be embedded in the UHWM electronic form. In some implementations, such information may be included in a multi-dimensional signature value (hash value), which may be embedded in the form. Further, the updated UHWM electronic form and associated data may be stored in a memory of the device and may be sent to the waste management system through a network.

At any stage of the transportation of the shipping container, if the shipping container is removed from the vehicle, a change in the total weight is determined, triggering another signature event. Each signature event may cause a graphical interface of a computing device associated with the responsible party to prompt a user for an electronic signature. The signature may represent the transporter's acceptance of the waste products in the manifest and the transporter's confirmation of the contents as well as assumption of responsibility for the handling of those contents. Further, the device may automatically capture image data associated with the operator, the containers, the waste products, or any combination thereof. Receipt of the signature may cause the device to update and store the UHWM electronic form and associated data in a local memory and to send the updated UHWM electronic form and associated data to the waste management system.

Finally, when the shipping container is delivered by the transporter to the TSDF (or disposal site), another signature event is generated in which a user at the TSDF signs the UHWM electronic form and assumes responsibility for the waste products. In some instances, the weight of the sealed shipping container may be verified again prior to acceptance. The user at the TSDF may sign the UHWM electronic form, such as by signing via a touch-sensitive surface. The signature on the UHWM electronic form may represent the TSDF's acceptance of the waste products in the manifest and the TSDF's confirmation of the contents as well as assumption of responsibility for the handling of those contents. The computing device may also capture an image of the signer. The UHWM electronic form may be updated with a multi-dimensional signature value based on the TSDF's signature and the image. The multi-dimensional signature value may be embedded in the UHWM electronic form using a device associated with the transporter of the waste product. Further, the updated UHWM electronic form and associated data may be stored in a memory of the device and may be sent to the waste management system through a network.

In some implementations, a waste management system may include one or more server devices configured to store data related to a waste item capture, collection, transportation, and disposal. The data may be collected at each point in the process and appended to a block chain type of data record, which may be stored in the one or more server devices and optionally at one or more additional computing devices (such as the computing devices of the source, destination, and transporters). In an example, each change in handlers, each change in weight or other attributes may be detected and incorporated into the block chain data. The block chain may represent an audit trail for waste sources, transporters, TSDFs, and oversight agencies. The block chain of each UHWM electronic form may allow an investigator to review each transaction within the process and to determine the status of the container and the company and person or people responsible for the product. Further, the UHWM electronic form may be retrieved from the block chain using any of the devices. The waste management system may store multiple versions of the waste data, so that each individual change is recorded and maintained, together with information about who made the change, when the change was made, and so on. In some implementations, multiple servers and individual computing devices may store a copy of the block chain data, providing a reliable, distributed backup. Moreover, the various servers may use a consensus model to ensure that data committed to the block chain servers is valid, before the data is appended to the block chain.

In some implementations, at each stage, the user may capture image data associated with a barcode, for example, of the shipping container. In response to scanning the barcode, the device may retrieve a copy of the UHWM electronic form from the waste management system. The retrieved copy of the UHWM electronic form may be updated with the signature data and a multi-dimensional signature (including image data of the signer) and the updated version of the UHWM electronic form may be sent to the waste management system. Alternatively, new data may be appended to the UHWM electronic form. Each version of the information may be stored. The waste management system may store each version of a UHWM electronic form together with associated information, providing a source-to-destination tracking mechanism.

Moreover, in some implementations, at each stage, the contents, weight, and other aspects of the shipping container, and optionally the individual waste products, may be verified by the user assuming responsibility. Any changes in the contents, weight, or any combination thereof may be detected, an alert may be generated, and the data may be appended to the record. Thus, the waste management system may capture and store multi-stage audit data of the waste disposal process. In particular, the waste management system may verify data from each scan or signature event against prior data. A signature event may be triggered by any change to the waste container, the contents, and so on. When a waste container is passed from one responsible party to a next responsible party, a signature event may be triggered, causing the computing device to prompt for a signature and capture an image of the signer. Any changes to the shipment may cause the waste management system to generate an alert to one or more of the responsible parties. Further, at each stage, should a waste product require special care, the waste management system (or any device in the process) may generate an alert to the responsible party. Further, if there is an error in the transfer or documentation process, the waste management system (or any device in the process) may generate an alert. This alerting mechanism may bring any discrepancies to the attention of the parties at the time of the exchange, making it possible to verify and correct discrepancies before assuming responsibility.

In some implementations, a device may capture optical data associated with an adhesive seal used to close and seal a shipping container. Minute variations in the size of the seal, the orientation of the seal relative to the edge of the container, creases in the seal, printing on the seal, and so on may be used to generate a statistically unique hash value. Once the shipping container is sealed, the initial image of the seal and the surrounding area of the container may be used to generate the unique hash value. For example, minute color variations, scratches, other container variations, or any combination thereof may be combined with the position of the seal, printing on the seal, wrinkles in the seal, air bubbles in the seal, and other information to produce the unique hash value. In one implementation, the numerous visual attributes may provide a large number of different possible values (such as over a trillion different combinations of information), providing a statistically unique value. At each transfer, optical data associated with the seal and the surrounding area of the container may be captured again. The hash value for the seal may be calculated based on the newly captured optical data. The calculated hash value may be compared to a hash value stored by the waste management system. If differences between the calculated hash value and the stored hash value is less than a threshold difference, the device may determine with statistical certainty that the shipping container has not been opened since it was sealed. A digital camera of a conventional smartphone device or a camera associated with a commercially available tablet computing device may have one or more cameras that have sufficient resolution to capture variations that may not be visible to the naked eye. Thus, the devices may use optical data to verify that the shipping container has not been tampered with. Other implementations are also possible.

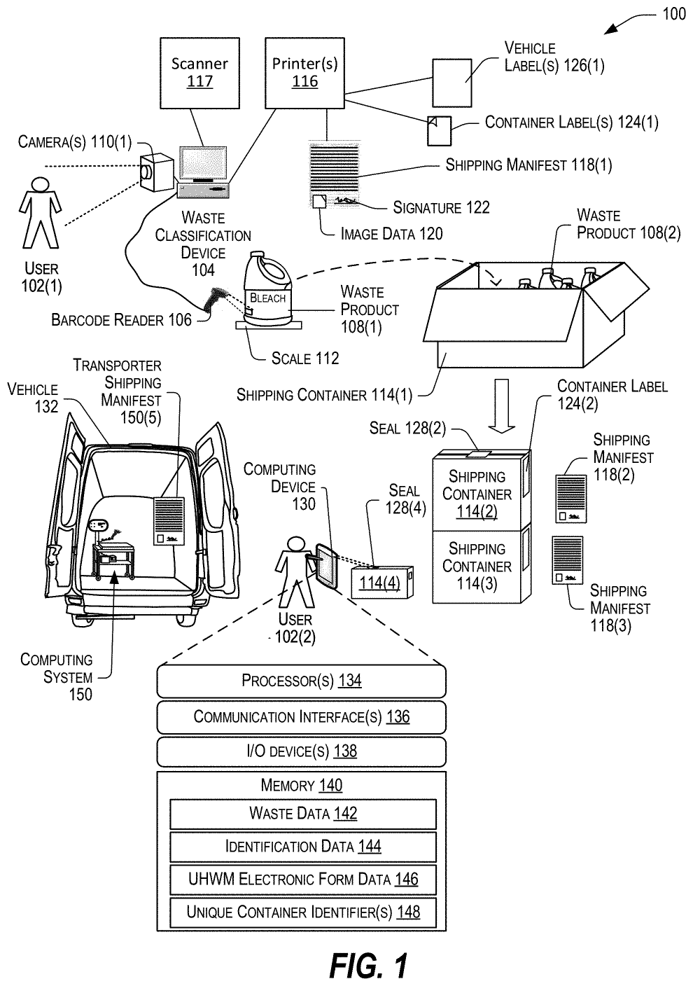

FIG. 1 depicts a diagram of a system 100 to capture data related to waste products 106 and to generate a shipping manifest 118 including integrated audit data, in accordance with certain embodiments of the present disclosure. A user 102(1) may utilize a waste classification device 104 to process waste products 108. As used herein, the term “waste product” may refer to any retail product that is unsaleable by a retailer and is therefore being disposed of.

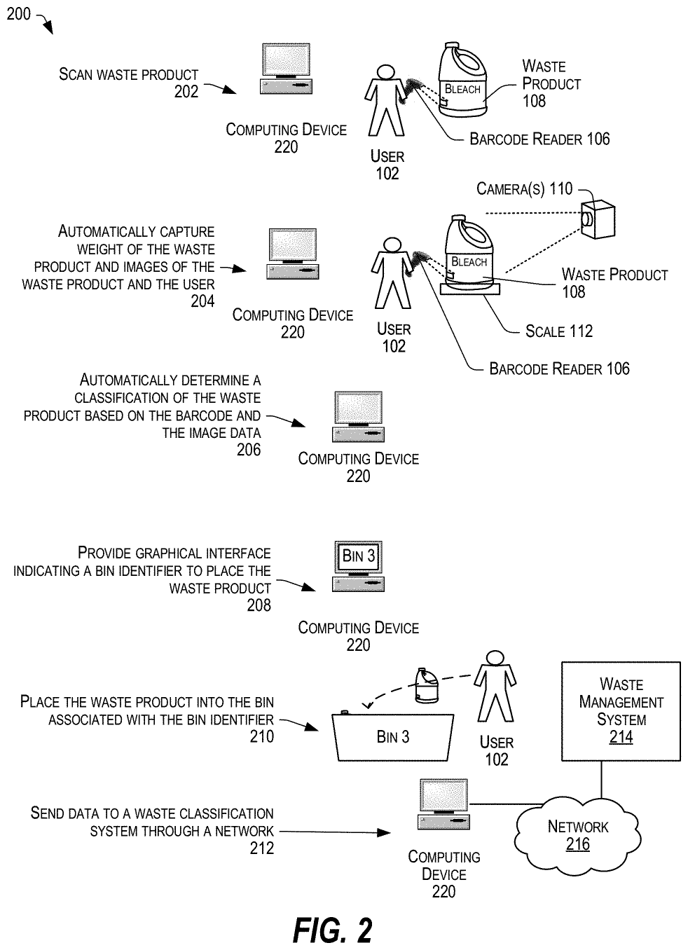

The user 102(1) may be an authorized employee of a waste generator (or source of a waste product). The source may be a retailer, a manufacturer, or another entity. The waste classification device 104 may be a computing device, such as a desktop, laptop, smartphone, or tablet computing device, which may be configured to execute processor-executable instructions to cause a processor to capture data associated with waste products 108. The captured information may be sent to a waste management system (such as the waste management system 214 in FIG. 2) through a network, and the waste management system 214 may communicate the data to a computing device 152 or a computing device 130 associated with a transporter. In some implementations, the computing device 130 may communicate with the computing device 152 through a short-range wireless communications link, such as a Bluetooth communications link.

A transporter may include a user 102(2) with a vehicle 132 configured to transport the waste products 108. The vehicle 132 may include a computing device 152, which may include a display, a processor, and one or more network transceivers. The computing device 152 may include or be coupled to a barcode reader, a scanner, a keyboard, a scale, other input devices, or any combination thereof. The computing device 152 may also include one or more output devices, such as a label printer, a dot-matrix printer for printing data on pre-printed forms, a speaker, and so on.

In some implementations, the computing device 152 may communicate with a handheld computing device 130, such as a tablet computer, a smartphone, or another portable computing device. The computing device 152 may receive the waste product information from the waste management system 214 in FIG. 2 and may provide the waste product information to the display. The user 102(2) may review the information and then may verify the waste products, for example, by using a camera of the portable computing device 130 or the barcode reader of the computing system. The user 102(2) may then print the information onto a pre-printed UHWM form. In some implementations, such as where the transporter is authorized to sign the UHWM form on behalf of the source of the waste products, the UHWM form may be printed with the name of the user 102(2) printed onto the UHWM form or shipping manifest.

In some implementations, instead of or in addition to sending the waste product information to the waste management system 214 (in FIG. 2), The waste classification device 104 may print labels 124 and waste manifests 118. The waste classification device 104 may include or may be coupled to one or more of a barcode reader 106, one or more cameras 110, a scale 112, or a printer 116. The user 102(1) may utilize the barcode reader 106 to scan a barcode of a waste product 108(1), and the waste classification device 104 may utilize the barcode of the waste product 108(1) to determine the product type, contents, and other parameters of the waste product 108(1). The waste classification device 104 may determine attributes of the waste product 108(1) and may provide a graphical interface to a display of the waste classification device 104 to indicate to the user 102(1) details related to the waste product 108(1). The graphical interface may further specify a shipping container 114(1) of a plurality of shipping containers 114 into which the waste product 108(1) should be placed based on identification of the waste product 108(1).

Once the shipping container 114(1) is full, the user 102(1) may access a graphical interface provided by a display of the waste classification device 104. The graphical interface may include a UHWM electronic form (EPA e-manifest) with a signature field accessible by the user 102(1) to sign the UHWM electronic form. The waste classification device 114 may then control the printer 116 to print the UHWM electronic form 118(1) including data related to the waste products 108, image data 120, and a signature 122, which may include the signature of the user 102(1) and optionally a multi-dimensional signature value including one or more of data related to the waste products 108, image data, date/time data, location data, other data, or the signature. In an example, the multi-dimensional signature value may be implemented as a “quick response” code or QR code that contains a matrix of visual elements that can be optically scanned and processed by a computing device, such as a smartphone to extract information to enable verification of the handling of a waste product 108 from source to destination.

In some implementations, the waste classification device 104 may utilize the one or more cameras 110(1) to capture image data associated with the waste product 108(1), image data associated with the user 102(1), or both. While only one camera 110(1) is shown, the one or more cameras 110(1) may include a first camera to capture an image of the user 102(1) and a second camera to capture an image of the waste product 108(1). The image data may be included in the multi-dimensional signature.

The waste classification device 104 may also control the printer 116 to generate container labels 124, which may be placed on the shipping container. The container label 124(1) may be an adhesive label and may include hazards information, routing address information, other information, or any combination thereof. In some implementations, the container label 124(1) may be coupled to the shipping container 114(1) and may operate as a seal 128, sealing the container 124 closed. Further, the waste classification device 104 may control the printer 116 to generate vehicle labels 126, which may indicate hazardous materials signage for placement on an exterior of a vehicle during transport. In some implementations, the waste classification device 104 may control the printer 116 to generate a shipping manifest 118 (UHWM printed form) including a list of containers, their contents, and other information; a list of individuals or companies, the signatures, date, time, location, and other associated information; a manifest tracking number; a printer identifier; and other data. While current EPA rules allow for printing by only EPA printers, the UHWM printed form may be printed with a unique identifier associated with the printer, enabling distributed printing at any location with digital fingerprinting to trace the printing source. Other implementations are also possible.

The waste generator or source may package multiple shipping containers 114. Each shipping container 114 may be secured in a closed state by a seal 128. For example, the shipping container 114(2) may have a label 124(2), a seal 128(2), or both and may have an associated shipping manifest 118(2). The shipping container 114(3) may have a seal 128(3) (not shown), a label 124(3) (not shown), or both and may have an associated shipping manifest 118(3), and so on. In some implementations, each shipping container 114 may have an associated shipping manifest 118 or may share a shipping manifest 118 with one or more other shipping containers 114.

Upon closing of the shipping container 114, a seal 128, a label 124, or both may be applied to secure the shipping container 114 in a closed state. As the user 102(1) applies one or more of the label 124 or the seal 128 to one of the containers 114, one or more of the cameras 110 may capture optical data associated with the label 124 or seal 128 and of the user 102(1). In some implementations, the waste classification device 104 may generate a hash value corresponding to the optical data associated with the label 124 or seal 128 and a portion of the shipping container 114 surrounding the seal 128. This hash value may be sent, together with the image data, and the signed shipping manifest data to a waste management system through a network, such as the Internet. In some implementations, this hash value may be used to detect tampering, such as opening of the sealed container before it reaches its destination. For example, an image of the seal 128 or label 124 may be captured by cameras at each transfer of possession, and the hash value may be calculated from the newly captured image and then compared to the stored hash value. If the hash value differs from the stored hash value by more than a predetermined margin of error, the difference may be indicative of tampering.

The transporter may be represented by a user 102(2), who may have a computing device 130 and a vehicle 132 for processing and transportation of the shipping containers 114. The user 102(2) may utilize the computing device 130 to scan a container label 124(4) of the shipping container 114(4) to determine the shipping container and to capture image data of the seal 128(4) or label 124(4). In some implementations, the computing device 130 may be a tablet computer, laptop computer, smartphone, or another portable computing device including a display and a touch-sensitive surface that may be accessed by the user 102(2) to sign the UHWM electronic form. The computing device 130 may include one or more hardware processors 134, which may be configured to execute processor-readable instructions stored in a memory 140.

The computing device 130 may include one or more communication interfaces 136, which may include short-range wireless communications interfaces, wired communication interfaces, long-range wireless communication interfaces, or any combination thereof. In some implementations, the computing device 130 may be a smartphone including a subscriber identity module that may utilize radio frequency communication interfaces to communicate with a communications network, which may include mobile communication networks (cellular, digital, satellite, etc.), the Internet, local networks, or any combination thereof.

Further, the computing device 130 may include one or more input/output (I/O) devices 138. The I/O devices 138 may include input devices, such as a keypad, a stylus, a microphone, one or more cameras, a touch-sensitive interface, other input devices, or any combination thereof. The I/O devices 138 may also include output devices, such as a display, a speaker, other output devices, or any combination thereof. In some implementations, the display and the touch-sensitive interface may be combined in the form of a touchscreen.

The computing device 130 may further include a memory 140 configured to store processor-executable instructions and to store data. The memory 140 may include waste data 142 corresponding to one or more waste items identified from images or from the UHWM electronic form. The memory 140 may include identification data 144 including data about the user, data associated with various waste products, other data, or any combination thereof. The memory 140 may also store UHWM electronic form data 146 including signature data, multi-dimensional signature value (including image data, user data, other data, or any combination thereof), and including data corresponding to one or more waste items. In some implementations, the memory 140 may also include one or more unique container identifiers 148, which may uniquely identify each waste container relative to any other waste container 114.

The computing device 130 may utilize a camera of the I/O devices 138 to capture image data associated with a shipping container 114(4) to determine a first container identifier associated with a container label 124(4) and a second container identifier determined from optical data associated with the seal 128(4). The computing device 130 may use the communication interfaces 136 to communicate with a waste management system (e.g., a computer server through a communications network) based on the optical data to retrieve a signed UHWM electronic form (with associated signatures, multi-dimensional signatures, and so on) and to verify that the shipping container 114(4) has not been tampered with. The computing device 130 may calculate a hash value based on the image data of the seal 128(4) and may query to waste management system through the network to retrieve a hash value to verify whether the seal 128(4) has been tampered with. If the seal 128(4) is changed by more than a threshold amount, the computing device 130 may provide an indication that the container 114 may have been tampered with. The user 102(2) may need to open the shipping container 114(4), verify the contents, and re-seal the shipping container 114(4) prior to signing the UHWM electronic form. Otherwise, the user 102(2) may sign the UHWM electronic form and may load the shipping container 114(4) into the vehicle 132 for transport.

The computing device 130 may include identification data 144, which may be an identifier corresponding to a physically unclonable function associated with the device. For example, the device may have a unique identifier, such as a serial number coupled with an owner name or other indicia and optionally a date/time stamp, a GPS location, and a username, which may be used to track a data entry (or change) to a computing device and a user. Further, the computing device 130 may store waste data 142 determined from the retrieved shipping manifest 118(4) (or UHWM electronic form) and may store UHWM electronic form data 146 from the retrieved shipping manifest 118(4). After verification, the user 102(2) may place the shipping container 114(4) into the vehicle 132 and sign the shipping manifest 118(4) (i.e., the UHWM electronic form) to form a transporter shipping manifest 150(4) (i.e., an updated UHWM electronic form with the transporter's signature and a multi-dimensional signature value, which may include username data, image data, and so on). As the user 102(2) signs the shipping manifest 118(4), one or more cameras associated with the computing device 130 may capture image data associated with the user 102(2) as well as image data of the shipping container 114(4).

A previously verified and loaded shipping container 114(5) and its associated transporter shipping manifest 150(5) is shown. It should be appreciated that the transporter shipping manifest 150 a printed version of the UHWM electronic form (i.e., the shipping manifest 118) that is signed by the user 102(2), transferring responsibility for the handling of the waste products 108 within the shipping container 114 to the user 102(2) and to the transporter entity.

The computing device 130 may send the transporter shipping manifest 150 and associated data (such as image data of the user 102(2) and the signature data) to the waste management system together with date/time stamp information, location information, other information, or any combination thereof. The user 102(2) may then transport the shipping containers 114.

In some implementations, transfer of a shipping container 114 from a source to a transporter may require a signature of the user 102(1) and the signature of the user 102(2), which may be captured on a UHWM electronic form. The signatures may be executed at different times, or may be executed at transfer, depending on the implementation. Each signed UHWM electronic form may be stored separately, for example, as version 1 and version 1 of the UHWM electronic form.

In the examples described above, if the waste source packages the waste products 108 into the shipping container 114, prints the labels 124, and applies the seal 128 to the shipping container 114, the transporter's job is simplified and made significantly more efficient. In this example, the transporter may sign the manifest 118 and scan the manifest into the computing device 152, which may upload the signed manifest 118 (UHWM form) to the waste management system 214. Thus, the transporter may simply load the waste items into the truck; scan the label 124, the seal 126, or both; sign the manifest 118, and scan the manifest 118 using one or more of the computing device 152 or the computing device 130.

In another example, the user 102(1) may enter waste product information into the waste classification device 104, which may send the information to the waste management system 214. The waste management system 214 may send the information to one or more of the computing device 152 or the computing device 130. The user 102(2) may then access the computing device 152 or the computing device 130 to print the manifest 118, which he or she may carry to an employee of the source to acquire the signature. The user 102(2) may also sign the manifest 118 to produce the transporter shipping manifest 150(5) before scanning the shipping manifest 150(5). In this example, the information that is sent by the waste classification device 104 to the waste management system 214 is also sent from the waste management system 214 to the computing system 152 or computing device 130 of the transporter, which can facilitate the pick up of the waste products 108, making the pickup and transportation process more efficient than if the user 102(2) were to manually enter the information.

If the EPA removes the forms restriction requiring printing on an approved form that is produced by one of the companies on its approved list, the waste classification device 104, the computing device 130, the computing system 152, or another computing device may control a printer to generate the UHWM form or manifest 118. Such an implementation would increase the efficiency of the waste collection, transportation, and disposal process. For example, laser printers print much faster than dot-matrix printers, so even the speed with which forms may be printed will improve. Other efficiencies may also be realized.

FIG. 2 depicts a diagram 200 of a method of generating data related to a shipping container, in accordance with certain embodiments of the present disclosure. At 202, the user 102 may utilize a computing device 220 to scan a waste product 108. The computing device 220 may be an implementation of the waste classification device 104, the computing device 130, or the computing system 152 in FIG. 1.

The user 102 may scan the waste product 108 by placing the waste product 108 onto a scale 112 and exposing the waste product 108 to one or more optical devices, such as barcode readers 106 and cameras 110. The barcode readers 106 and the cameras 110 may capture optical data associated with the waste product 108.

At 204, the computing device 220 may automatically capture the weight and images of the waste product 108 and images of the user 102. For example, in response to the user 102 placing the waste product 108 onto the scale 112, the cameras 110 and the barcode reader 106 may automatically capture data corresponding to the waste product 108.

At 206, the computing device 220 may automatically determine a classification of the waste product 108 based on the barcode data and the image data. In some examples, the computing device 220 may automatically identify the waste product based on the barcode data by searching one or more data stores. The computing device 220 may determine attributes associated with the identified waste product and to determine which container of a plurality of containers 114 into which the waste product should be placed. In some implementations, it may be desirable to ship waste products 108 of the same or similar content in the same shipping container 114, such that the shipping container 114 has the same hazard codes and same shipping restrictions and requirements. Additionally, the waste classification device 104 may prevent two products from being placed together that, if mixed, may create a biohazard (such as chlorine bleach and an ammonia cleaner, which if mixed may produce chloramine gas).

At 208, the computing device 220 may generate a graphical interface including a bin or container identifier to place the waste product 108. For example, the computing device 220 may provide a graphical interface including a bin or container identifier. In this example, the bin or container identifier may include a identifying number, such as “Bin 3”, “Container 3”, or “Bleach”.

At 210, the user 102 may place the waste product 108 into the bin or container associated with the identifier. As mentioned above, the bin may be a shipping container 114. In an example, products of similar composition may be stored and transported in the same shipping container 114.

At 212, the computing device 220 may send data to a waste management system 214 through a network 216. The network 216 may include the Internet, one or more other communication networks, or any combination thereof. The data may include the waste product data, a signature associated with the user 102, image data associated with waste products, image data associated with a user, aggregated weight data, other data, or any combination thereof. The waste management system 214 may also store the UHWM electronic forms. Other implementations are also possible.

In an example, the method in the diagram 200 may be performed by a user 102 using a waste classification device 104 at a waste source. Alternatively, the method may be performed by a transporter (e.g., user 102(2)) using one or more of the computing system 152 or the computing device 130. Depending on the implementation, the computing device 220 may control a printer to print onto a pre-printed manifest form, to print labels, or any combination thereof.

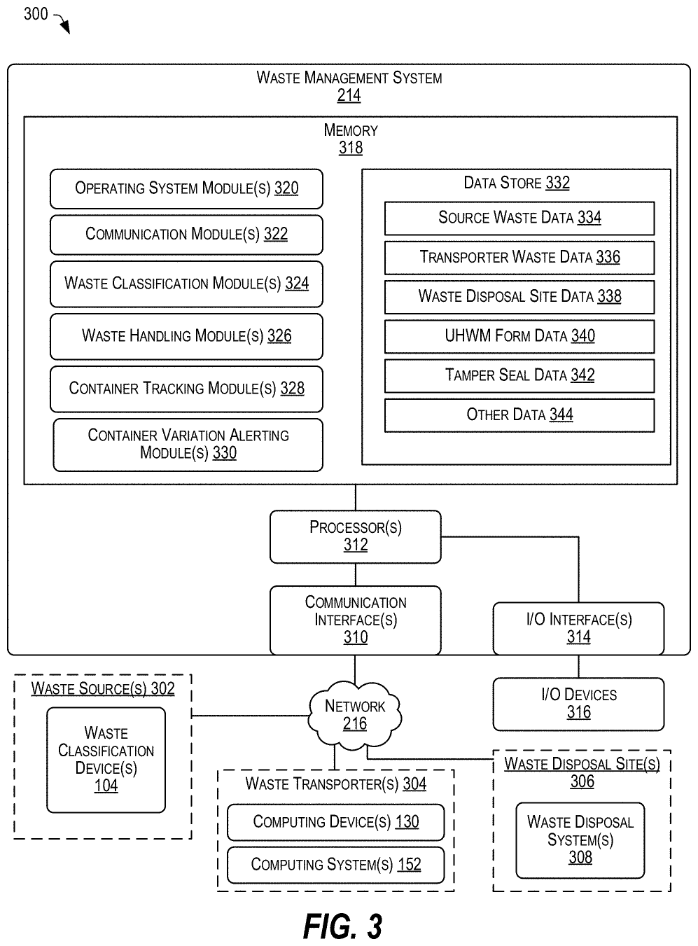

FIG. 3 depicts a block diagram 300 of a waste management system 214, in accordance with certain embodiments of the present disclosure. The waste management system 214 may include one or more computer servers executing instructions and configured to store data including UHWM electronic form data (EPA manifest data) and other data (including audit data, such as signatures, images, date and time stamps, geographic location data, other data, or any combination thereof).

The waste management system 214 may communicate with one or more waste classification devices 104 associated with one or more waste sources 302, one or more computing devices 130 associated with one or more waste transporters 304, and one or more waste disposal systems 308 associated with one or more TSDF sites 306 through the network 216. The network 216 may include the Internet, cellular or digital communication networks, one or more other networks, or any combination thereof.

The waste management system 214 may include one or more communication interfaces 310 to communicate data to and receive data from the network 216. The waste management system 214 may further include one or more processors 312 coupled to the communication interfaces 310. The processors 312 may be configured to execute processor-readable instructions.

The waste management system 214 may also include one or more input/output interfaces 314, which may be coupled to one or more input/output (I/O) devices 316. The I/O devices 316 may include input devices, such as cameras, microphones, scanners, barcode readers, keyboards, keypads, pointer devices, scales, touch-sensitive interfaces, or any combination thereof. The I/O devices 316 may also include output devices, such as display devices, printers, speakers, other devices, or any combination thereof. In some instances, the input device and the output device may be combined into a single unit, such as combining a touch-sensitive interface and a display to form a touchscreen, which may be an input/output device.

Further, the waste management system 214 may include a memory 318 coupled to the one or more processors 312. The memory 318 may include one or more non-volatile memory devices (hard disc drives, solid state memory devices, and so on). The memory 318 may store data and processor-executable instructions. The memory 318 may include one or more operating system (OS) modules 320 that may be executed by the processors 312 to control operation of the waste management system 214. The memory 318 may further include one or more communication modules 322 that may cause the processors 312 to control the communications interfaces 310 to send and receive data. In some implementations, the communication modules 322 may control the communications interfaces 310 to send data to and receive data from one or more of the waste classification devices 104, the computing devices 130, or the waste disposal systems 308 through the network 216.

The memory 318 may also include one or more waste classification modules 324 that may cause the processor 312 to receive optical data associated with one or more waste products 108 and to determine attributes associated with each of the waste products 108 based on the optical data. In some examples, the optical data may include barcode data, images of the product label, images of product containers, one or more images of a user, and so on. The one or more waste classification modules 324 may cause the processor 312 to receive the optical data from a waste classification device 104, retrieve waste classification data corresponding to the waste product 108 from one or more data sources in response to receiving the optical data, and send the classification data to the waste classification device 104. The waste classification data may include characteristics that can be used by one or more waste handling modules 326 to determine hazards requirements, labeling requirements, and shipping requirements associated with each of the waste products 108. The waste handling modules 326 may send data corresponding to the hazards requirements, the labeling requirements, and the shipping requirements to the waste classification device 104 or to a computing device 130 or computing system 152 of a waste transporter that is collecting the waste product.

The memory 318 may also include one or more container tracking modules 328 that may cause the processor 312 to receive UHWM form data from the waste classification devices 104, the computing devices 130, the waste disposal systems 308, or any combination thereof. The form data may include waste product data, user data, location data, time data, date data, other data, or any combination thereof. The received information may be used to populate a UHWM electronic form or to print onto a pre-printed UHWM form. The waste management system 214 may send a UHWM electronic form or the form data to a computing system 152 or computing device 130 of the transporter.

The container tracking module 328 may store data in a data store 322 corresponding to the geophysical location of each shipping container 114 and the associated UHWM form 118 or 150 (UHWM form data) for each shipping container 114. Data received from the devices 104 may be stored and the waste management system 214 may update the transporter waste data 336 and the UHWM form data 340. In some implementations, upon retrieval of waste products 108 from a source, the computing system 152 or the computing device 130 may communicate data related to the waste products 108 and the container 114 to the waste management system 214, and the container tracking module 328 may record the container data in the data store 332. Other embodiments are also possible.

The memory 318 may further include one or more container variation alerting modules 330, which may detect variations in the data associated with each shipping container 114 from the reported manifests and associated information. For example, if a measured weight of a shipping container changes by more than a threshold amount (which may be indicative of a calibration error), the container variation alerting module 330 may cause the processor 312 to generate an alert, such as a text message, an email message, an audio indicator, a visual indicator, a phone call, or any combination thereof. In response to detecting a variation that is greater than a threshold (such as a weight change that is greater than a calibration margin of error), the container variation alerting module 330 may generate an alert, which can be sent to one or more of the waste classification device 104, the computing device 130, or the waste disposal system 308. For example, the container variation alerting module 330 may send a text message, send an email, generate a phone call, or otherwise send an alert to another device through the network 216 or to one of the I/O devices 316.

In some implementations, the waste management system 214 may receive a signed UHWM form from a source (UHWM electronic form or scanned UHWM form) and may store the UHWM form in a data store 322 as UHWM form data 340. Subsequently, when the UHWM form is signed by a transporter or another user, the updated UHWM form may be received by the waste management system 214, which may compare the updated UHWM form to a previous version of the same form in the UHWM form data 340 to determine authenticity. For example, the container variation alerting module 330 may cause the processor 312 to determine a unique tracking number (manifest tracking number or MTN) on the updated UHWM form and to search the UHWM form data 340 to determine one or more previous versions of the same form. The container variation alerting module 330 may cause the processor 312 to compare one or more data points of the received UHWM form to corresponding data points of the one or more previous versions of the same form. Such data points may include the signatures, the waste product data, other data, or any combination thereof. In some implementations, the alerting module 330 may cause the processor to compare a multi-dimensional signature from the updated UHWM electronic form to a corresponding multi-dimensional signature from the one or more previous versions of the same form. If one or more of the multi-dimensional signatures from a previous signing event do not match the corresponding multi-dimensional signatures on the received form, the container variation alerting module 330 may cause the processor to detect an error and may generate an alert. The error may indicate one or more of a change in the waste data, a variation in the user data, a variation in the form, or other variations that may be indicative of a fraud or theft.

In some implementations, the multi-dimensional signature may include signature data of the user, an image of the user, data related to the waste products, date data, time data, location data, other data, or any combination thereof. In some implementations, the multi-dimensional signature may also include data determined from a previous multi-dimensional signature, establishing a linked chain of signature data that may be used for authentication. Other implementations are also possible.

In one implementation, the container variation alerting module 330 may generate a multi-dimensional signature value from data included in the UHWM form (electronic or scanned). In an example, the container variation alerting module 330 may perform image processing operations on the signature data to produce a multi-dimensional signature value. If the new version of the form has a multi-dimensional signature value (calculated from one or more of the signatures) that matches corresponding multi-dimensional signature values of the one or more previous versions, a new multi-dimensional signature value may be determined from a newly added signature plus data from a previously determined multi-dimensional signature value for the same UHWM form. Thus, the multi-dimensional value for each subsequent signature includes data related to the previous signature, providing a linked chain that can be used to verify authenticity.

The memory 318 may further include a data store 332, which may store source waste data 334, transporter waste data 336, waste disposal site data 338, UHWM form data 340 (from one or more sources), tamper seal data 342, and other data 344. In some implementations, the UHWM form data 340 may be included within the waste data from the various sources. Other implementations are also possible.

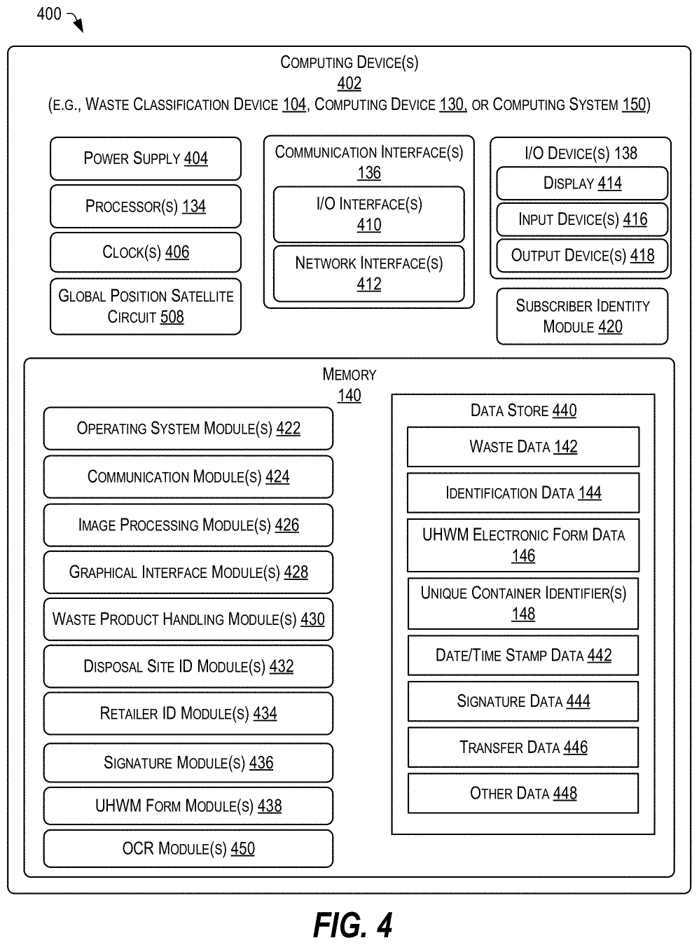

FIG. 4 depicts a block diagram 400 of a computing device 402, in accordance with certain embodiments of the present disclosure. The computing device 402 may be smartphone, a laptop, a tablet computer, a desktop computer, or other computing device. The computing device 402 may be an implementation of the waste classification device 104, the computing device 130, or the computing system 152. The computing device 402 may be configured to be portable to allow a user 102(2) associated with a transporter to carry the computing device 402 or alternatively to transport the computing device 402 within a vehicle 132.

The computing device 402 may include a power supply 404, which may include a rechargeable battery and circuitry to convert an alternating current to a direct current. The computing device 402 may further include one or more hardware processors 134, and one or more clocks 406. The computing device 402 may further include a global positioning satellite circuit 408 to generate information indicative of a geophysical location of the computing device 402.

The computing device 402 may also include a communications interface 136 including input/output (I/O) interfaces 410 and network interfaces 412. The computing device 402 can also include I/O devices 138. The I/O devices 138 may include input devices 416, such as a keyboard, a keypad, a stylus, a pointer, a touchscreen, a camera, a barcode reader, a microphone, a touch-sensitive interface or touch pad, other input devices, or any combination thereof. The I/O devices 138 may also include output devices 418, such as display devices, speakers, printers, other output devices, or any combination thereof. In some implementations, the I/O devices 138 may include a combination input/output device, such as a touchscreen.

The computing device 402 may include a subscriber identity module 420 (or subscriber identification module (SIM) or SIM card), which may be an integrated circuit configured to securely store an international mobile subscriber identity (IMSI) number and its related key. The IMSI number and the related key may be used to identify and authenticate subscribers on mobile telephony devices (such as smartphones, computers, and so on) for authentication to a cellular or digital communications network.

The computing device 402 may also include a memory 140, which may store data and processor-readable instructions. The memory 140 may store one or more operating system modules 422 that may be executed by the processors 134 to control operation of the computing device 402. The memory 140 may further include one or more communication modules 424 that may cause the processors 134 to control the communications interfaces 136 to send and receive data.

The memory 140 may further include one or more image processing modules 426 to receive image data from optical devices of the one or more input devices 416 and to extract data from the image data. The extracted data may include a barcode, a product name, image data associated with a seal, image data associated with a label, other data, or any combination thereof. Further, the image data may include images of the user 102, images of the shipping container 114, other data, or any combination thereof

The memory 140 may also include one or more graphical interface modules 428 that may generate graphical interfaces that can be provided to the display 414. The graphical interfaces may include data, instructions, prompts, and selectable options accessible by the user 102 to review, edit, and sign a UHWM form. In some implementations, the graphical interface modules 428 may display the UHWM form with one or more fields to receive an electronic signature. In other implementations, the graphical interface modules 428 may cause the processor 134 to display the UHWM form and to access a selectable control to print the UHWM form using one of the output devices 418. The user 102 may sign the UHWM form and then access a scanner to of the input devices 416 to scan the UHWM form. Other implementations are also possible.

The memory 140 may also include waste product handling modules 430 that may cause the processor 134 to present information indicating waste product handling regulations or processors based on the waste products in a selected container 114. The memory 140 may also include disposal site ID modules 432 that may include identifiers associated with a waste disposal site 306 and retailer ID modules 434 that may include identifiers associated with a waste source 302.

Further, the memory 140 may include one or more signature modules 436 that may cause the processor 134 to require a signature on a UHWM form, to verify the signature, and to process the signature with other information to produce a multi-layer signature value, which can be incorporated into the UHWM form (electronic form) or stored with the UHWM form in the data store 440. The memory 140 may also include one or more UHWM form modules 438 that cause the processor to update the manifest to produce a transporter shipping manifest 150.

The memory 140 may further include a data store 440 that may include waste data 142, identification data 144, UHWM form data 146, and unique container identifiers 148. The data store 440 may also include date/time stamp data 442, signature data 444, transfer data 446, and other data 448.

The computing device 402 may include an optical carriage recognition (OCR) module 450 that, when executed, may cause the processor 134 to process content within a scanned version of the UHWM form to extract data. In some implementations, the OCR module 450 may extract a preprinted manifest tracking number (MTN) from the scanned UHWM form and may use the MTN retrieve previous version of the UHWM form from memory 140 or from the waste management system 214. Additionally, the MTN may be used to store the version of the UHWM form in a database.

In some implementations, as a container is removed from the truck, a scanning event is generated. The user may scan the container using a barcode reader or camera. The computing device 402 may present a graphical interface including an input field to receive a signature of the person assuming responsibility. The computing device 402 may insert the signature in the UHWM electronic form and may update the data store 440 with date/time stamp data 442, signature data 444, transfer data 446, and other data 448 may be updated. Alternatively, the computing device 402 may print the UHWM form on which the user may sign, and the signed form may be scanned into the system. In this instance, the scanned UHWM form may be stored together with the corresponding date/time stamp data 442, signature data 444 determined from the scanned signature, and so on. Other implementations are also possible.

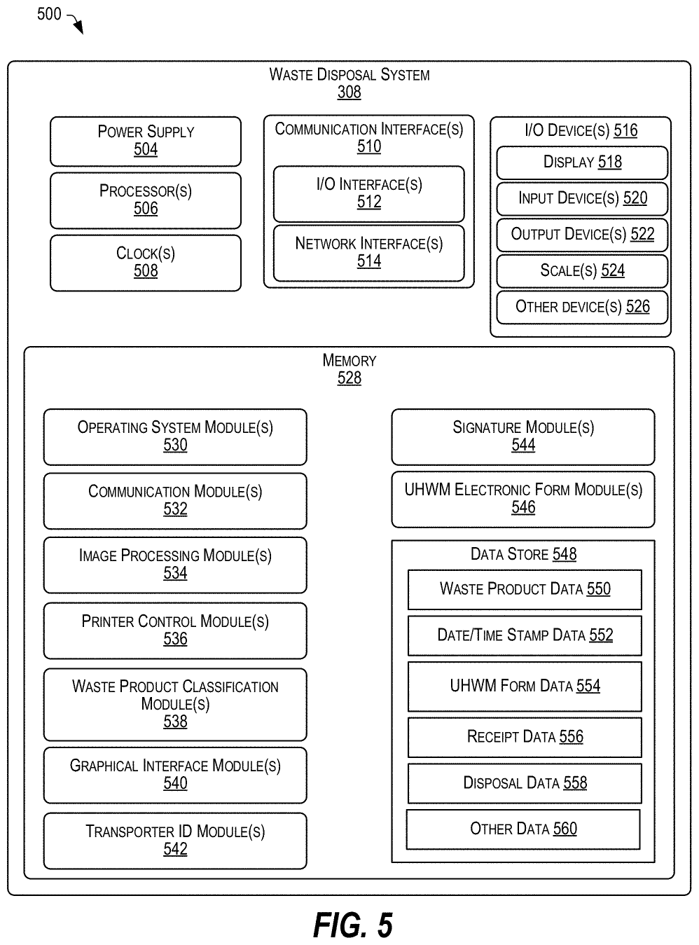

FIG. 5 depicts a block diagram 500 of a waste disposal system 308, in accordance with certain embodiments of the present disclosure. The waste disposal system 308 may be a computing system of a waste disposal sites (e.g., treatment, storage, and disposal facilities (TSDFs)). The waste disposal system 308 may include one or more computing devices. The waste disposal system 308 may include a power supply 504 configured to supply power to the components of the waste disposal system 308.

The waste disposal system 308 may further include one or more hardware processors 506 to execute processor-executable instructions and to process data. The waste disposal system 308 may further include one or more clocks 508 to provide signals that can be used to produce time/date stamp data as well as to drive various activities of the processors 506 and other components.

The waste disposal system 308 may include one or more communication interfaces 510, which may include input/output (I/O) interfaces 512 and network interfaces 514. Further, the waste disposal system 308 may include I/O devices 516 including a display 518, one or more input devices 520 (such as a touch-sensitive interface, a keypad, a keyboard, a pointer, a stylus, a microphone, one or more cameras, a barcode reader, a scale 524, other input devices, or any combination thereof), one or more output devices 522 (such as a keyboard, a keypad, a stylus, a display (such as the display 518), a speaker, a printer 526, other output devices, or any combination thereof), one or more scales 524 to weigh a waste product 108, other input devise, other output devices, or any combination thereof.

The waste disposal system 308 may include a memory 528 that stores data and processor-readable instructions. The memory 528 may include one or more operating system (OS) modules 530 that may be executed by the processors 506 to control operation of the waste disposal system 308. The memory 528 may further include one or more communication modules 532 that may cause the processors 506 to control the communications interfaces 510 to send and receive data.

The memory 528 may further include one or more image processing modules 534 to receive image data from one or more of the input devices 520 and to extract data from the image data. The extracted data may include a barcode, a product name, image data associated with a seal or label, other data, or any combination thereof. The memory 528 may further include one or more printer control modules 536 to control the one or more printers 526 to print the UHWM form including each of the signatures. In some implementations, the printer control modules 536 may be configured to include a unique printer identification number that can be used to trace a printed UHWM form to its source.

The memory 528 may also include one or more waste product classification modules 538 that may cause the processor 506 to analyze the data extracted from the image data, to search one or more data sources to determine attributes associated with the waste product 108 based on the extract data, and to determine hazards, transportation, and disposal data for a particular waste product 108. For example, the waste product classification module 538 may identify the waste product 108 based on the optical data and may retrieve hazards, transportation, and disposal data based on the identified waste product 108. In some implementations, the waste classification module 538 of the waste disposal system 308 may communicate with the waste management system 214 to retrieve or confirm the hazard, transportation, and disposal data from the waste product 108.

The memory 528 may also include one or more graphical interface modules 540 that may generate graphical interfaces that can be provided to the display 518. The graphical interfaces may include data, instructions, prompts, and selectable options accessible by the user 102 to review, edit, and sign a shipping manifest. Other implementations are also possible.

The memory 528 may include one or more transporter ID modules 542, which may include data associated with one or more of the transporters that deliver the shipping containers 114 to the waste disposal site 306. Further, the memory 528 may include one or more signature modules 544 that may cause the processor 506 to require a signature on a transporter shipping manifest 150, to verify the signature, and to process the signature with other information to produce a multi-layer signature value, which can be incorporated into the transporter shipping manifest 150. The memory 528 may also include one or more UHWM form modules 546 that cause the processor to update the transporter UHWM form (shipping manifest 150) to reflect receipt by the waste disposal site 306.

The memory 528 may further include a data store 548 that may include waste data 550, date/time stamp data 552, UHWM form data 554, receipt data 556, disposal data 558, and other data 560. The receipt data 556 may include data related to receipt of a shipping container 114. Further, the disposal data 558 may include information related to the burning, recycling, or other disposal of the waste products 108 within the shipping container 114. Other implementations are also possible.

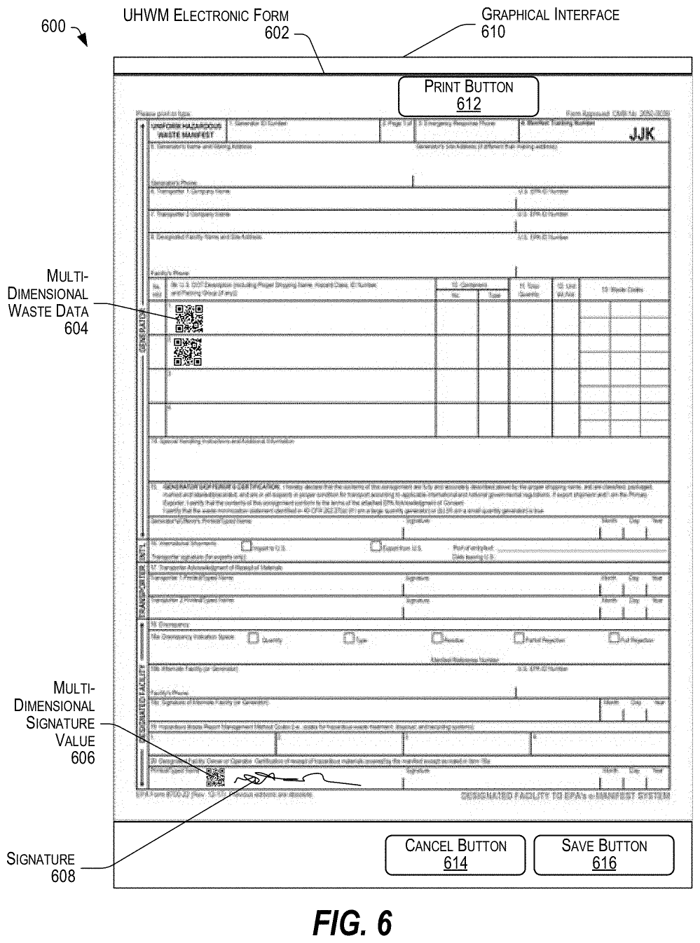

FIG. 6 depicts a diagram 600 of a form including integrated audit data, in accordance with certain embodiments of the present disclosure. The form may be a UHWM form (e.g., an EPA manifest form) 602. The UHWM form 602 may be presented within a graphical interface 610, which may include one or more control options that may be accessed by a user to initiate one or more operations. In an example, the control options may include a print button 612, a cancel button 614, and a save button 616. Other control options may also be included.

In the illustrative example, the form 602 is largely incomplete and is presented only for illustrative purposes. The user at the source may initially populate the UHWM form 602 with data related to the waste products, including itemized list elements identifying the waste items, quantity, weight, image data, and other information. in some implementations, the user may then apply a digital signature 608 to the UHWM electronic form 602. In other implementations, the user may print the UHWM form 602 and may physically sign the form 602.

In some implementations, the waste classification device 104 may generate multi-dimensional waste data 604 based on the waste data that populates the form 602. Further, the multi-dimensional waste data 604 may include product data, weight data, date/time data, location data, images of the products, images of the user(s), user data, other data, or any combination thereof. In some implementations, the multi-dimensional waste data 604 may include one or more embedded uniform resource locators (URLs) that may be accessed to confirm user information and other data associated with the waste product collection and packaging process.

The waste classification device 104 may also generate a multi-dimensional signature value 606 based on the signature 608 and other data, including date/dime data, location data, user data, other data, or any combination thereof. The multi-dimensional signature value 606 may be generated, in part, from an electronic signature or from an image of the signature determined from a scan operation. The multi-dimensional signature value 606 may include links or embedded information enabling validation of the manifest. In the illustrated example, the multi-dimensional signature value 606 is depicted as a quick-response code (QR code) but could be implemented in other ways.

In some implementations, the waste classification device 104, the computing device 130, the computing system 152, and the waste disposal systems 308 may each be configured to add data that may be incorporated into the UHWM form 602 and one or more of the waste classification device 104, the computing device 130, the computing system 152, and the waste disposal systems 308 may be configured to update the form with multi-dimensional waste data 604, multi-dimensional signature values 606, or both. The data may be stored in a local memory and sent to the waste management system. Other implementations are also possible.

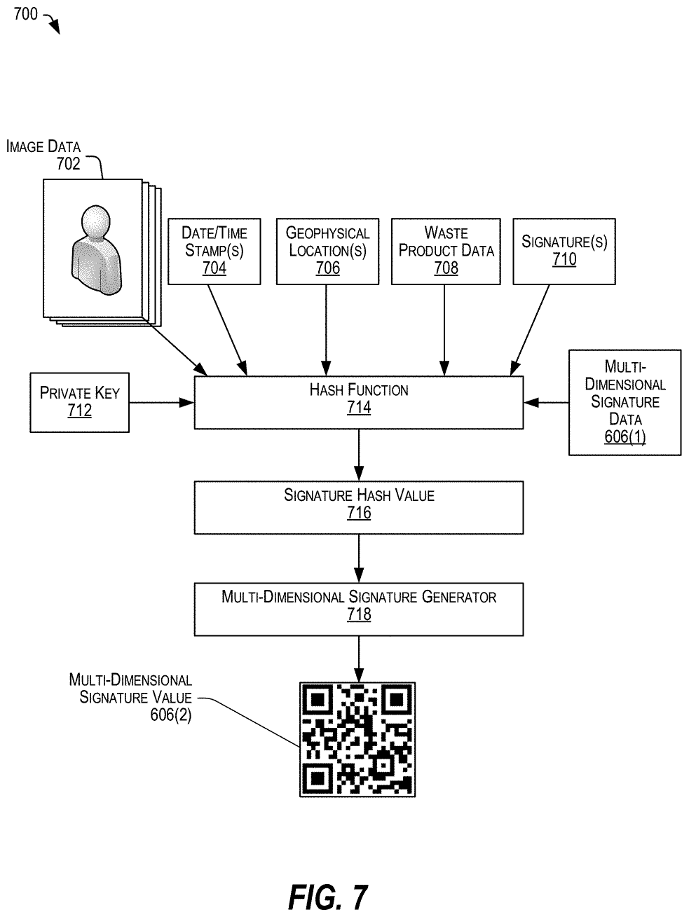

FIG. 7 depicts a block diagram 700 of a method of generating a multi-dimensional signature value 606, in accordance with certain embodiments of the present disclosure. In the illustrated example, image data 702 may include images of the signatory, whether the signatory is the user 102(1) at a waste generator or source, a user 102(2) associated with the transporter, or a user 102(3) at a waste disposal site 306. Further, the image data 702 may include images of the waste products, the shipping container, labels, and other information. The image data 702 may be provided to a hash function 714, together with date/time stamps 704 associated with each image and with collection of data for each of the waste products 108. Further, the hash function 714 may receive geophysical location data 706 corresponding to the locations associated with the capture of each image and with collection of the data for each of the waste products 108.

The hash function 714 may further receive waste product data 708 and one or more signatures 710, such as data from a current signature and one or more previous signature 710 or data from a previous multi-dimensional signature value 606(1). The hash function 714 may also receive a private key 712. In response to the inputs, the hash function 714 may produce a signature hash value 716, which may be provided to a multi-dimensional signature generator 718. The multi-dimensional signature generator 718 may process the signature hash value 716 to produce a multi-dimensional signature value 606(2).

In some implementations, the multi-dimensional signature value 706 may include a digitally signed message, which may be decrypted by the waste management system 214 to resolve data associated with the handling of the waste products 108. The digitally signed message may include an embedded audit trail data that may be processed to evaluate the handling of a shipping container 114 including one or more waste products 108. For example, the multi-dimensional signature value may represent a linked value that links a second version of the UHWM form (i.e., a first UHWM form that was previously signed by a first user and that has now been signed by a second user to produce a second version). Since the multi-dimensional signature value 606(2) may include data from the current signature 710 and a previous multi-dimensional signature value 606(1), the multi-dimensional signature value 606(2) may provide an embedded audit or verification mechanism that can be used to verify the authenticity of the UHWM form.

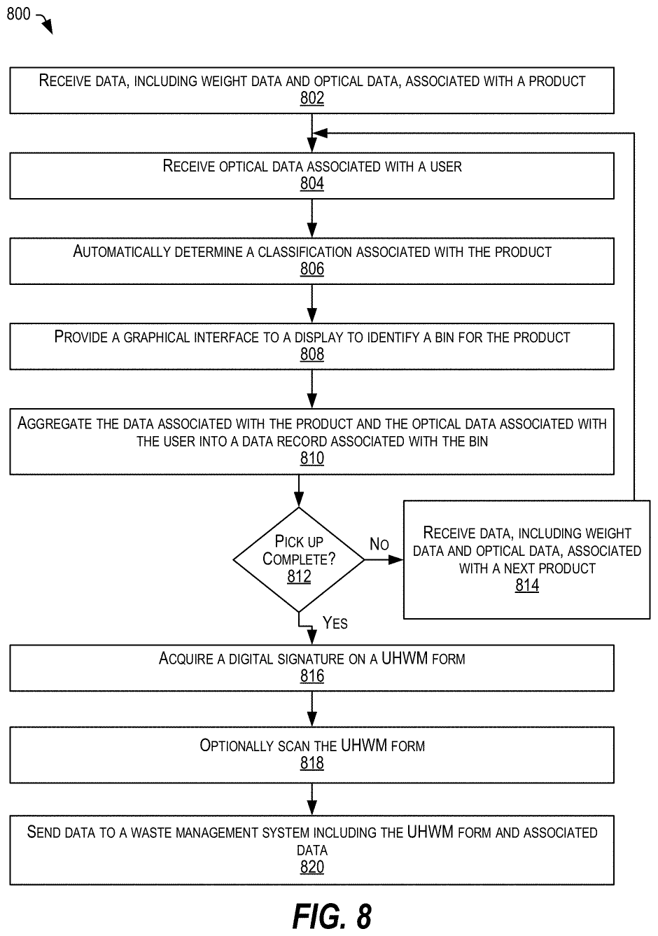

FIG. 8 depicts a block diagram 800 of a method of generating a shipping manifest, in accordance with certain embodiments of the present disclosure. At 802, data including weight data and optical data associated with a product may be received. For example, the data may be received at a processor of a waste classification device 104 from a scale 112 and from one or more cameras 110, a barcode reader 106, or a combination thereof. In another example, the data may be received at a computing system 152 or a computing device 130 of a transporter from a waste management system 214 through a network 216. In this example, the source may enter the data into a graphical interface and submit the data to the waste management system 214, which may communicate the data to the transporter to facilitate and enhance the efficiency of the pick up operation.

At 804, the optical data may be received that is associated with a user. In an example, the cameras 110 may capture images of the user 102(1) while the user 102(1) is scanning the waste product 108.

At 806, a classification associated with the product is automatically determined. For example, the waste classification device 104 may extract data from the images, including UPC data, barcode data, other data, or any combination thereof. The waste classification device 104 may search one or more data sources to determine hazard, transportation, and disposal regulations associated with the waste product 108.

At 808, a graphical interface may be provided to a display to identify a bin for the product. The waste classification device 104 may indicate a shipping container 114 into which the waste product 108 should be placed. In an example, waste products of similar composition may be shipped together within a single shipping container 114.

At 810, data associated with the product and optical data associated with the user are aggregated into a data record associated with the bin. For example, the product information, the weight, and other information may be combined with user image data and stored in the data record of the bin.

The method 800 may include determining whether the pick up event is complete, at 812. In this example, the transporter may arrive at a waste source to pick up pre-determined waste products 108. Once the waste products 108 are collected, the transporter may need to move on to a next waste source to pick up additional waste. However, before leaving, the transporter may need to acquire signatures on the UHWM form, either electronically or on a paper form). At 812, if the pick up event is not complete, data is received including weight data and optical data associated with a next product, at 814. At 814, the data may be received from an input device of the transporter, such as a keyboard, a barcode reader, or other input device. Alternatively, the data may be received from the waste management system 214. The process may then return to 804 to receive optical data associated with a user.

Otherwise, at 812, if the pick up event is complete, a digital signature is acquired on a UHWM form, at 816. In some implementations, the computing system 152 may communicate data to the computing device 130 that includes the waste data 108 and other data, and the computing device 130 may display a UHWM form with one or more signature fields to acquire one or more signatures within a graphical interface on a display of a computing device. One or more users 102 may sign the UHWM form within the graphical interface by using a stylus or by signing on a touch-sensitive interface. Alternatively, the signature may be acquired by printing the data onto a preprinted UHWM form and having the user 102 sign the printed UHWM form.

At 818, the method 800 may include optionally scanning the UHWM form. If the signature is acquired digitally, this step may be omitted. Otherwise, the user 102 may provide the signed UWHM form to a scanner to capture scanned images of the signed UHWM form.

At 820, the method 800 may include sending data to a waste management system 214 including the UHWM form and associated data. The associated data may include location data where the UHWM form was generated or scanned, date and time data associated with the signing or scanning of the UHWM form, image data associated with one or more users 102, other data, or any combination thereof. Other implementations are also possible.

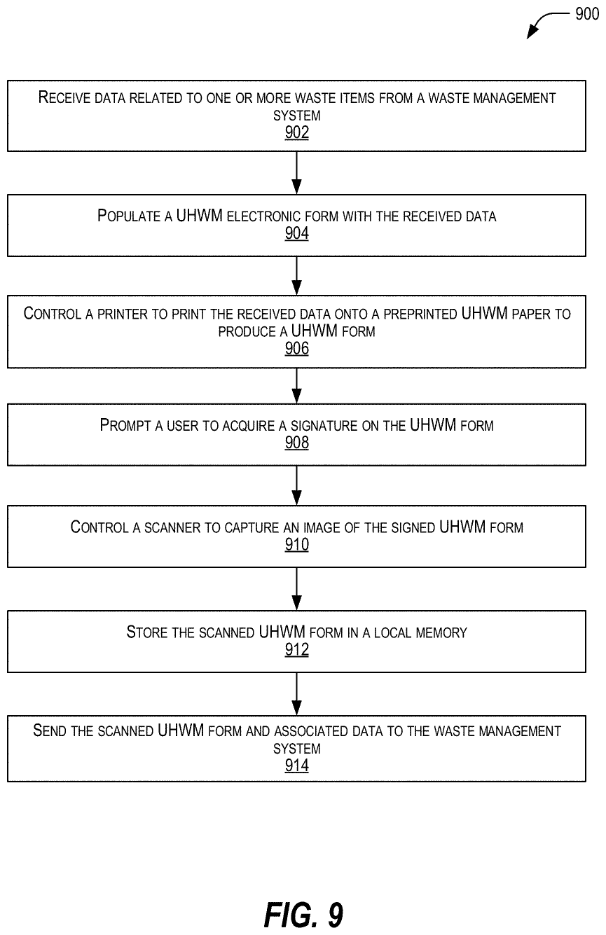

FIG. 9 depicts a flow diagram of a method 900 of capturing data related to a signed shipping manifest, in accordance with certain embodiments of the present disclosure. At 902, the method 900 may include receiving data related to one or more waste items from a waste management system. In an example, a user at a computing device, such as a waste classification device 104, of a waste source (such as a retail store) may capture or enter data related to one or more waste products, such as household hazardous waste products, to be disposed of. Depending on the implementation, the user may initiate a printing operation to print the data onto a UHWM form or may send the data to the waste management system 214. In the latter case, the transporter may need to generate the UWHM form, and the waste management system 102 may operate to transmit the data to the transporter's computing device for printing of the form. In the example of block 902, the user may send the data to the waste management system 214, and the waste management system 214 may send the data related to the one or more waste items to the transporter's computing device 130 or 150, and the transporter's computing device may receive the data related to the one or more waste items.

At 904, the method 900 may include populating a UHWM electronic form with received data. The UHWM electronic form may look like a printed UHWM form on a display of the computing device 130 or 150, and the user may interact with the computing device to enter additional data or to view or edit the populated data.

At 906, the method 900 may include controlling a printer to print the received data onto a preprinted UHWM paper to produce a UHWM form. At this time, the EPA allows only pre-approved companies to print the multi-layer form. Accordingly, the printer may print the data onto a paper form printed by one of the EPA-authorized vendors. The user may interact with a print button or menu option to initiate printing of the form, and the computing device may control the printer to print the data onto the form. In some implementations, the transporter may be authorized to sign the form on behalf of the waste source, and, in such instances, the computing device 130 or 150 may print a name in the signature block, which may be indicative of such authorization.

At 908, the method 900 may include prompting a user to acquire a signature on the UHWM form. In an example, the computing device 130 or 150 may provide a popup or other visual prompt to the display to prompt the user to sign. The user may then sign the printed UHWM form,

At 910, the method 900 may include controlling a scanner to capture an image of the signed UHWM form. In an example, the computing device 130 or 150 may prompt the user to scan the signed UHWM form. A scanner or camera associated with the computing device 130 or 150 may scan the signed UHWM form in response to a signal from the computing device 130 or 150.

At 912, the method 900 may include storing the scanned UHWM form in a local memory. The computing device 130 or 150 may store the scanned UHWM form on its hard disc or solid-state memory.

At 914, method 900 may include sending the scanned UHWM form and associated data to the waste management system. In an example, the waste management system 102 may store the signed UHWM forms in a database.

Each UHWM form has a unique identifier, and the database may store each UHWM form according to its identifier. Alternatively, the UHWM form may be stored according to the source from which the form is received. Other implementations are also possible.

In conjunction with the systems, methods, and devices described above with respect to FIGS. 1-9, a system may be configured to enable source-to-destination tracking and auditing of waste shipping manifests, such as Environmental Protection Agency (EPA) Electronic manifests (E-Manifests) or UHWM forms, which may be scanned versions of the paper form or which may be implemented as UHWM electronic forms. The waste shipping manifest (or UHWM form) may include a tracking number, such as a manifest tracking number or MTN. From the source to the transporter and from the transporter to the Treatment, Storage, and Disposal Facility (TSDF) (and every step in between), the UHWM form may be presented to each user to acquire a signature and a computing device may capture images of the user who is signing the form. In some implementations, the images may be captured of a user who is scanning a signed version of the UHWM form into the computing system 152.

If the UHWM form is entirely electronic, the UHWM form may be printed, and a code may be included on the printed version of the UHWM form so that the printer itself, the date, the time, and the location of the printing may be determined from the code. Additionally, the signature data and the signed UHWM electronic form may be sent to a waste management system 214, which may maintain a centralized database of UHWM form data, together with related audit information.

Embodiments of the systems, methods, and devices described above with respect to FIGS. 1-9 may be configured to capture signature data and image data at each stage of the waste handling process, enabling source-to-destination tracking of waste data, and providing an audit trail that can be used to retrace the steps and to hold individuals or companies accountable (or to provide an audit trail that may vindicate a company accused of mishandling such waste). In some examples, waste data, signature data, and image data associated with the signer (as well as username and other information), previous signature data, other data, or any combination thereof may be combined to form a multi-dimensional signature value, which may be embedded in the UHWM electronic form or stored with data associated with a scanned version of the UWHM form and which may be accessed at any time to verify the signatories and the waste data. Other implementations are also possible.

In some implementations, the system may include hardware devices that enable scanning of waste products, automatic classification of the waste products, and tracking of waste products from source-to-destination and every stage in between. Data embedded in the UHWM electronic form or stored with the scanned UHWM form may enable auditing of waste products and associated UHWM form data as the waste products are transferred from one responsible party to the next. For example, the UHWM electronic form may be created by a user at the source or associated with a transporter using a computing device. The user of the device may scan, upload, or otherwise enter data related to each waste product and may digitally sign the UHWM electronic form, for example, by signing on a touch-sensitive surface or a touchscreen. Alternatively, the user may print the form, one or more users may sign the printed UHWM form, and then the user may scan the form into the computing device. The signature may represent confirmation by the signer that the contents of the UHWM form were verified by the signer and that the signer assumes responsibility for the accuracy of the contents of the UHWM form (digital or scanned). In some implementations, the digital signature may be applied to the UHWM electronic form and a multi-dimensional signature value may be embedded into the UHWM electronic form. In some implementations, the user may print a copy of the UHWM electronic form for his/her records. Alternatively, in some implementations, the user may print the UHWM data onto a preprinted UHWM form and have one or more users sign the UHWM form. The signed form may then be scanned into the computing device. Additionally, the UHWM form (electronic or scanned) may be stored in a memory of the computing device and may be sent to a waste management system through a network for remote storage.

When the waste products are transferred from the source to a waste transporter, the transfer of the waste products initiates a signature event in which a driver or other user associated with the transporter may sign the UHWM form (digitally or on paper, which may be scanned into the system), acknowledging the transfer and assuming responsibility for the waste products. In some implementations, prior to signing, the weight of the sealed shipping container may be verified. The signature on the UHWM form may represent the transporter's acceptance of the waste products in the manifest and the transporter's confirmation of the contents as well as assumption of responsibility for the handling of those contents. The computing device used by the transporter to sign the UHWM form may capture images of the user during signing or scanning. The UHWM electronic form may be updated with the transporter's signature as well as a multi-dimensional signature value based on the transporter's signature, the images, date data, time data, location data, waste data, other data, or any combination thereof. Further, the updated UHWM electronic form may be stored in a memory of the computing device, and the updated UHWM electronic form may be sent to the waste management system through a network. Alternatively, the paper form may be scanned and may be uploaded with data associated with the transporter, the date, the time, images, location data, and so on for storage in the data store of the waste management system.

In some implementations, the waste management system may compare the updated UHWM form to a previous version of the same form to determine authenticity. If one or more of the multi-dimensional signatures from a previous signing event do not match the corresponding multi-dimensional signatures of the received form, the waste management system may detect an error and may generate an alert.

At any stage of the transportation of the shipping container, if the shipping container is removed from the vehicle, another signature event is generated. Each signature event may cause a graphical interface of a computing device associated with the responsible party to prompt a user for a signature. The signature may represent the transporter's acceptance of the waste products in the manifest and the transporter's confirmation of the contents as well as assumption of responsibility for the handling of those contents. As the user signs the UHWM electronic form, the computing device may capture one or more images of the signer. Alternatively, the user 102(2) may capture an image of the signer 102(1) signing the paper form. Receipt of the signature may cause the device to append the signature and a multi-dimensional signature to the UHWM electronic form, to store the updated UHWM electronic form, and to send the updated UHWM electronic form to the waste management system. Alternatively, receipt of the scanned version of the UHWM form may be stored and may be sent to the waste management system for storage.

When the shipping container is delivered by the transporter to the TSDF (or disposal site), another signature event is generated in which a user at the TSDF signs the UHWM form, acknowledging receipt, and assuming responsibility for the waste products. The contents of the shipping container and the weight of the shipping container may be verified prior to acceptance. Once accepted, the user at the TSDF may sign the UHWM electronic form, such as by signing on a touch-sensitive surface or may sign a paper version of the UHWM form. The signature on the UHWM electronic form may represent the TSDF's acceptance of the waste products listed, confirmation of the contents, and assumption of responsibility for the handling of those contents. The UHWM electronic form may be updated with a multi-dimensional signature value based on the TSDF's signature, which may be embedded in the UHWM electronic form using a device associated with the transporter of the waste product. Alternatively, the UWM form may be printed, signed, and scanned into the computing device. Further, the updated UHWM form and associated data may be stored in a memory of the device, and the updated UHWM form and the associated data may be sent to the waste management system through a network.

In some implementations, at each stage, the user may capture image data associated with a barcode, for example, of the shipping container. In response to scanning the barcode, the device may retrieve the UHWM form from the waste management system. The retrieved UHWM electronic form may be updated with the signature data and the updated version of the UHWM electronic form may be sent to the waste management system or the scanned version of the UHWM form may be provided to the waste management system. The waste management system may store each version of a UHWM form together with associated information, providing a source-to-destination tracking mechanism.

Moreover, in some implementations, at each stage, the contents, weight, and other aspects of the shipping container, and optionally the individual waste products, may be verified by the user assuming responsibility. Any changes in the contents, weight, or any combination thereof may be determined, providing a multi-stage audit of the waste disposal process. In particular, the waste management system may verify data from each UHWM form against prior received data. Any changes may cause the waste management system to generate an alert to one or more of the responsible parties. Further, at each stage, should a waste product require special care, the waste management system (or any device in the process) may generate an alert to the responsible party. Further, if there is an error in the transfer or documentation process, the waste management system (or any device in the process) may generate an alert.

In some implementations, a device may capture optical data associated with an adhesive seal used to seal a shipping container. Minute variations in the size of the seal, the orientation of the seal relative to the edge of the container, creases in the seal, printing on the seal, and so on may be used to generate a statistically unique hash value. Once the shipping container is sealed, the initial image of the seal and the surrounding area of the container may be used to generate the unique hash value. At each transfer, optical data associated with the seal and the surrounding area of the container may be captured again. The hash value for the seal may be calculated based on the newly captured optical data. The calculated hash value may be compared to a hash value stored by the waste management system. If differences between the calculated hash value and the stored hash value is less than a threshold difference, the device may determine with statistical certainty that the shipping container has not been opened since it was sealed. A digital camera of a conventional smartphone device or a camera associated with a commercially available tablet computing device may have one or more cameras that have sufficient resolution to capture variations that may not be visible to the naked eye, and such variations may be used for the hash value and for confirmation of the hash value. Thus, the devices may use optical data to verify that the shipping container has not been tampered with. Other implementations are also possible.

A system may include a combination of hardware and software that enables the source-to-destination (cradle-to-grave) tracking and auditing of waste shipments using a UHWM electronic form. The UHWM electronic form can be provided with a digital tracking signature, such as a scannable barcode (UPC) or unique manifest tracking number. From the source, to the TSDF (Treatment Storage and Disposal Facility), and every step in between, the UHWM electronic form may be updated with signatures of those assuming responsibility and each updated (signed) version of the UHWM electronic form may be stored at a waste management system. The electronic signature data may be added at each stage, as each new user signs the UHWM electronic form, creating a new version of the form. The signature data may be combined with one or more of image data (of the signer), date data, time data, GPS location data, or other data (such as data determined from a previous signature) to provide multi-dimensional signature value that represents a linked, digital audit trail that can be used to verify and validate the manifest.

In one possible implementation, hardware devices (such as the waste classification device 104, the computing device 130, the computing system 152, or the waste disposal system 308) may include optical devices that allow for the scanning of a waste product 108, a shipping container 114 or 150, and so on. The devices may further include a processor that can be used to track and audit UHWM electronic forms as the shipping container 114 and the associated shipping manifest transfers from one responsible party to the next. The devices may also provide one or more printers, including a first printer to print shipping labels and hazard labels and a second printer to print UHWM forms. The devices may also include a scanner to scan paper versions of the UHWM form.

The waste management system 214 may automatically synchronize data containing UHWM electronic form data with databases that reside on the hardware devices (waste classification device 104, computing device 130, computing system 152, waste disposal system 308, or other devices), as desired. Further, each of the devices may be configured to provide a graphical interface that allows a user 102 to look-up, edit, sign, and audit UHWM electronic form data or to initiate printing of the UHWM form.

In some implementations, the waste management system 214, any of the devices (waste classification device 104, computing device 130, computing system 152, waste disposal system 308, or other devices), or any combination thereof may provide automated alerting and notifications associated with UHWM form data should physical items require special care or if there should be an error in the transfer or documentation process.

In some implementations, any or all of the waste management system 214, the waste classification device 104, the computing device 130, the computing system 152, the waste disposal system 308, or other devices may communicate the UHWM form to the Environmental Protection Agency (EPA), the waste generator (waste classification device 104 or another computing device associated with the waste source 302), the Department of Transportation, a disposal facility (the waste disposal system 308 of the waste disposal site 306), and so on.

In the various embodiments, a tablet computer or other computing device may be used to digitally capture UHWM electronic form signature(s) or to print and scan a UHWM form. In some implementations, the tablet computer or another computing device may be used to display required shipping documentation to an employee of the Department of Transportation, without printing the manifest (or with printing of the manifest upon request).

In some embodiments, the data collected by the waste classification device 104 may include barcode and other information, which may be included or linked to waste container information provided on lines within the UHWM form. Further, in some implementations, the waste classification device 104, the computing device 130, the computing system 152, the waste management system 214, or the waste disposal system 308 may automatically determine which hazards are associated with waste products by scanning the barcodes on those products, looking up the characteristics of those waste products in a database, using those characteristics to determine the hazards, labeling, and shipping requirements associated with those waste products, printing those codes or information on manifests, shipping containers and on labels for the outside of vehicle. Further, with the addition of the scale 112 and cameras 110, the waste classification system can automatically identify the product and optionally determine the quantity of product. Other implementations are also possible.

Although the present invention has been described with reference to preferred embodiments, workers skilled in the art will recognize that changes may be made in form and detail without departing from the scope of the invention.

What is claimed is:

1. A system comprising:
a computing device comprising:
a communications interface to communicate with a communications network;
an input/output device including a touchscreen;
a processor coupled to the network interface, the display, and the touch-sensitive interface; and
a memory accessible to the processor and configured to store data and processor-executable instructions that, when executed, cause the processor to:
provide an interface including a Uniform Hazardous Waste Manifest (UHWM) electronic form to the touchscreen, the UHWM electronic form including one or more fields, the one or more fields including a signature field to receive an electronic signature;
receive data corresponding to the UHWM electronic form including a digital signature;
store the UHWM electronic form in a datastore within the memory; and
send the UHWM electronic form and associated data to a waste management system through the communications network.

2. The system of claim 1, wherein the computing device further comprises a camera to capture image data associated with a user in response to receiving the digital signature.

3. The system of claim 2, wherein the processor-executable instructions cause the processor to generate a multi-dimensional signature value including data determined form one or more of a date stamp, a time stamp, geophysical location data, the digital signature, the image data, or a previous multi-dimensional signature value.

4. The system of claim 2, wherein the associated data includes the image data.

5. The system of claims 3, wherein the waste management system comprises:
a communications interface to communicate with the network;
a processor coupled to the communications interface; and
a memory accessible to the processor, the memory to store data and to store processor-readable instructions that, when executed, cause the processor to:
receive the UHWM form and associated data;
determine an identifier associated with the UHWM form;
search one or more data stores to identify a previous version of the UHWM form based on the identifier;
compare the previous multi-dimensional signature value from the previous version of the UHWM form to a selected multi-dimensional signature value of the received UHWM form; and
generate an alert when the previous multi-dimensional signature value differs from the selected multi-dimensional signature value.
compare one or more first values of the first UHWM electronic form to one or more second values of the updated version of the first UHWM electronic form; and
generate an alert in response to a difference between the one or more first values and the one or more second values.

6. The system of claim 5, wherein:
the one or more first values include one or more first multi-dimensional signature values; and
the one or more second values include a version of the one or more first values.

7. The system of claim 6, wherein the processor-readable instructions cause the processor to compare one or more first values of the first UHWM electronic form to one or more second values.

8. A system comprising:
a waste management system comprising
a communications interface to communicate with a network;
a processor coupled to the communications interface; and
a memory accessible to the processor, the memory to store data and to store processor-readable instructions that, when executed, cause the processor to:
receive data related to a Uniform Hazardous Waste Manifest (UHWM) form from a first computing device through the network;
store the UHWM form in a data store within the memory;
receive an updated version of the UHWM form from one of the first computing device or a second computing device through the network;
store the updated version of the UHWM form in the data store;
compare one or more first values of the UHWM form to one or more second values of the updated version of the UHWM form; and
generate an alert in response to a difference between the one or more first values and the one or more second values.

9. The system of claim 8, wherein:
the UHWM form includes one or more first multi-dimensional signature values; and
the updated version of the UHWM form includes one or more second multi-dimensional signature values including a version of the one or more first multi-dimensional signature values.

10. The system of claim 8, wherein the associated data includes the image data associated with a user of the first computing device.

11. The system of claim 8, wherein the processor-readable instructions cause the processor to:
receive a second UHWM form from one or more of the first computing device or a second computing device;
store the second UHWM form in the datastore.

12. The system of claim 8, further comprising:
a computing device comprising:
a communications interface to communicate with a communications network;
an input/output device including a touchscreen;
a processor coupled to the network interface, the display, and the touch-sensitive interface; and
a memory accessible to the processor and configured to store data and processor-executable instructions that, when executed, cause the processor to:
provide an interface including the UHWM form to the touchscreen, the UHWM form including one or more fields, the one or more fields including a signature field to receive a digital signature;
receive data corresponding to the UHWM form including the digital signature;
store the UHWM form in a datastore within the memory; and
send the UHWM form and associated data to a waste management system through the communications network.

13. The system of claim 12, wherein the computing device further comprises a camera to capture image data associated with a user in response to receiving the digital signature.

14. The system of claim 13, wherein the processor-executable instructions cause the processor to generate a multi-dimensional signature value including data determined form one or more of a date stamp, a time stamp, geophysical location data, the digital signature, the image data, or a previous multi-dimensional signature value.

15. A method comprising:
providing a graphical interface to a touchscreen of a computing device, the graphical interface including a Uniform Hazardous Waste Manifest (UHWM) form including a signature input field;
receiving a signed version of the UHWM form;
capturing image data corresponding to a user concurrently with receiving the signed version; and
sending the signed version of the UHWM form to a waste management system through a network.

16. The method of claim 15, further comprising:
automatically capturing, using the computing device, image data associated with each of the waste products and with a user operating the computing device;
automatically weighing each of the waste products;
automatically determining a classification for each of the waste products; and
automatically populating the UHWM form based on the capturing, the weighing, and the determining.

17. The method of claim 15, further comprising:
determining a multi-dimensional signature value based on one or more of signature data, date data, time data, location data, or waste data associated with the signed version of the UHWM form; and
storing the multi-dimensional signature value with the UHWM form.

18. The method of claim 17, further comprising:
capturing image data associated with a user in response to receiving the signed version; and
wherein the multi-dimensional signature value includes data related to the image data.

19. The method of claim 15, wherein the multi-dimensional signature value comprises an optically readable code.

20. The method of claim 15, further comprising:
in response to receiving the signed version of the UHWM form, determining a manifest tracking number from the UHWM form;
retrieving a previous version of the signed version of the UHWM form from a data store;
comparing first data from the signed version of the UHWM electronic form to second data from the previous version; and
generating an alert when the first data differs from the second data by more than a threshold amount.
